(19) United States
(12) Patent Application Publication
(10) Pub. No.: US 2009/0150592 A1
(43) Pub. Date: Jun. 11, 2009

(54) Storage device with multiple management identity and management method thereof

(76) Inventors: Hsiao-Chang KUO, Jhubei City (TW); Yi-Chu Liao, Kaohsiung City (TW)

Correspondence Address: SINORICA, LLC, 528 FALLSGROVE DRIVE, ROCKVILLE, MD, 20850, US

(21) Appl. No.: 12/103,612

(22) Filed: Apr. 15, 2008

(30) Foreign Application Priority Data
Dec. 6, 2007 (TW) 096146581

(51) Int. Cl. G06F 12/00

(52) U.S. Cl. 711/100; 711/E12.001

(57) ABSTRACT

A storage device with multiple management identities and a management method thereof are disclosed. The storage device includes a first storage space corresponding to a first management identity and a second storage space corresponding to a second management identity. By a control unit, the storage device is coupled with the first storage space as well as the second storage space and selects the first storage space or the second storage space according to a selection signal corresponding to the first management identity or the second management identity so as to provide the first storage space or the second storage space being used by a computer space. Thus the convenience of use of the storage device is improved.

### BACKGROUND OF THE INVENTION

The present invention relates to a storage device, especially to a storage device with multiple management identities and a management method thereof.

The way of storage devices to retrieve data includes a fixed type and a portable type. The fixed type storage device such as hard disk has larger storage space for saving large amount of data and programs. However, the shortage of the fixed type storage device is that they are not available anywhere, anytime users need to use them immediately. The convenience of use leads to the popularity of the portable storage device. There are various types of portable storage devices available now such as micro drivers, memory sticks (MS), and compact flash card (CF card). Although they can save data, the portable storage device doesn't have data management and space management functions.

No matter the portable storage devices are used in enterprises or for individuals, the same one storage device may be used by multiple users. Due to different requirements of each user, everyone has his personal data that needs to be in secret. Conventional fixed type storage devices are unable to be partitioned and secured completely. As to hard disks, although it can be cut into several areas, there is no mechanism to encrypt each area respectively. This may cause safety problems of the data. Moreover, the operation systems available now can only encrypt specific files or data. Once each file and data in certain area needs to be encrypted one after another, users got in a lot of trouble for that.

Thus there is a need to provide a new storage device with multiple management identities and a management method thereof that increase convenience of use of the storage device. Moreover, one of the storage space in the storage device is a read only storage space that is saved with an application program so as to prevent deletion of the application program. Furthermore, an identification process is added for preventing the data jacking.

### SUMMARY OF THE INVENTION

Therefore it is a primary object of the present invention to provide a storage device with multiple management identities and a management method thereof that improves convenience of use of storage devices by shift of the management identity of the storage device.

It is another object of the present invention to provide a storage device with multiple management identities and a management method thereof that prevents deletion of application programs by means of a read only storage space in the storage device.

It is a further object of the present invention to provide a storage device with multiple management identities and a management method thereof that adds an identification process when the control unit selects the first storage space or the second storage space so as to prevent data jacking and improves data safety.

In order to achieve above objects, a storage device with multiple management identities according to the present invention includes a first storage space, a second storage space, and a control unit. A management method of the storage device with multiple management identities includes a plurality of steps. Firstly, couple the control unit with the first storage space and the second storage space. Then according to a selection signal corresponding to a first management identity or a second management identity, select the first storage space or the second storage space to be used by a computer system.

Moreover, while the control unit selecting the first storage space or the second storage space, it further performs an identification process having steps of checking a user name and confirming a password.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of an embodiment according to the present invention;

FIG. 2 is a flow chart of an embodiment according to the present invention;

FIG. 3 is a block diagram of another embodiment according to the present invention;

FIG. 4 is a flow chart of another embodiment according to the present invention;

FIG. 5 is a block diagram of a further embodiment according to the present invention;

FIG. 6 is a flow chart of a further embodiment according to the present

### DETAILED DESCRIPTION OF THE PREFERRED EMBODIMENT

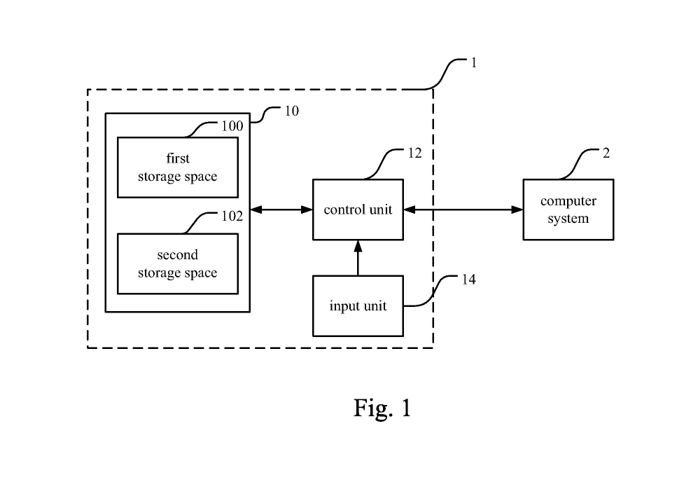

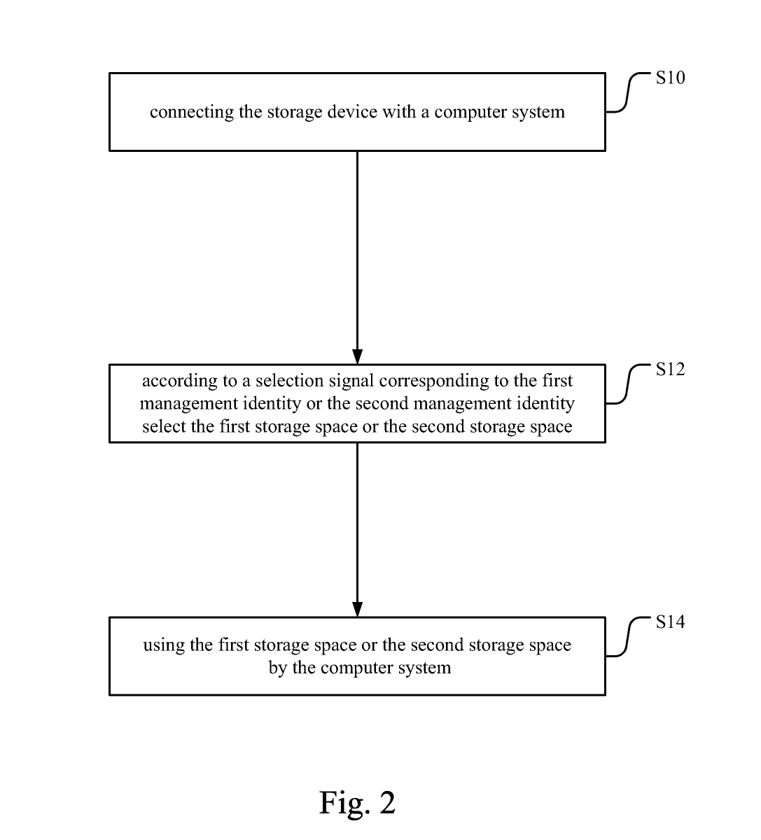

Refer to FIG. 1 & FIG. 2, a storage device with multiple management identities 1 includes a storage unit 10 and a control unit 12. The storage unit 10 consists of a first storage space 100 and a second storage space 102 that respectively correspond to a first management identity(ID) and a second management ID. The storage unit 10 either provides two addresses for the first storage space 100 and the second storage space 102 or the storage unit 10 is cut into two storage areas for the first storage space 100 and the second storage space 102 respectively.

A management method of the storage device with multiple management identities includes a plurality of steps. Firstly, run the step S10, connect the storage device 1 with a computer system 2 while the control unit 12 is coupled to the first storage space 10 and the second storage space 12. Then according to a selection signal corresponding to the first management identity or the second management identity, select the first storage space 10 or the second storage space 12, as shown in the step S 12. While the storage device 1 connecting with the computer system 2, the computer system 2 uses the first storage space 10 or the second storage space 12, as shown in the step S14. That means the user can chose to use the first storage space 10 or the second storage space 12 of the storage device 1 according to his needs. By the shift of the management identity of the storage device 1, the convenience of use of the storage device 1 is improved. Moreover, the storage device 1 is disposed on a portable device or a plug and play device such as a portable disk, an optical disk drive, a digital player or a digital photo frame.

Furthermore, the storage device 1 further includes an input unit 14 that is coupled to the control unit 12. According to the management identities such as the first one or the second one, the input unit 14 generates a selection signal that is sent to the control unit 12 so as to select the first storage space 100 corresponding to the first management identity or the second storage space 102 corresponding to the second management identity for being used by the computer system 2. When the control unit 12 selects the first storage space 100 being used by the computer system 2, the computer system 2 is unable to identify the second management identity corresponding to the second storage space 102 of the storage device 1. The input unit 14 can be a push button. In addition, while the storage device 1 connecting with the computer system 2, by an input interface on the image displayed on the computer system 2, the user can choose to use the first storage space 100 or the second storage space 102 and a selection signal for selecting the first storage space 100 corresponding to the first management identity or the second storage space 102 corresponding to the second management identity is generated so as to decide which storage space—the first storage space 100 or the second storage space 102—to be used.

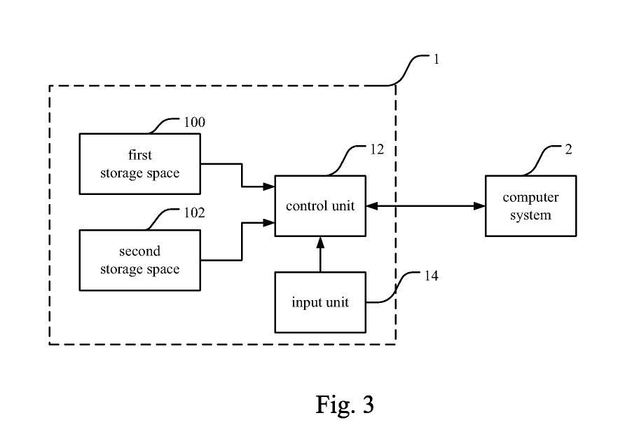

Moreover, the first storage space 100 and the second storage space 102 respectively can be an independent storage unit, as shown in FIG. 3. For example, the first storage space 100 and the second storage space 102 can be a flash memory.

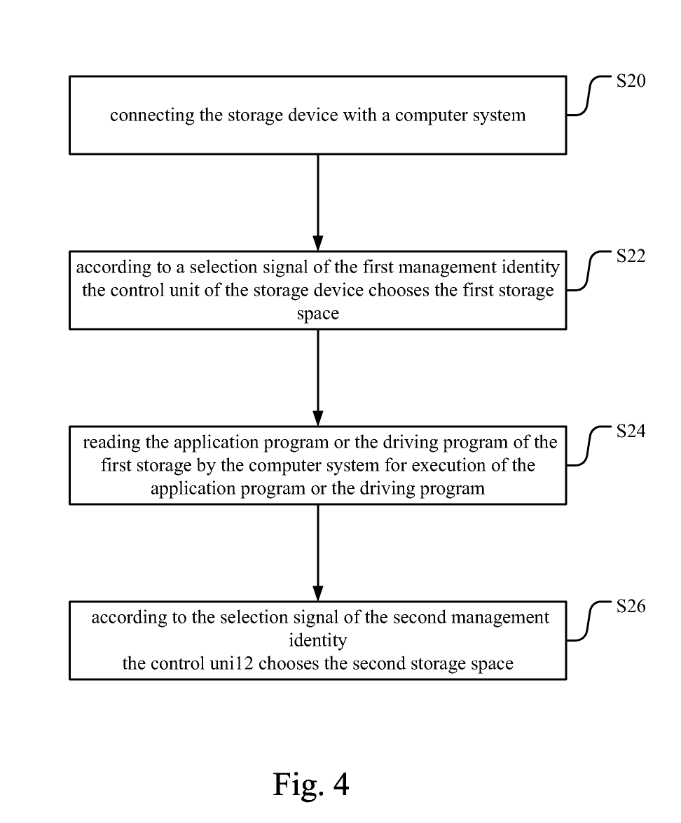

With reference of the FIG. 4, a flow chart of another embodiment is revealed. The difference between this embodiment and the embodiment in FIG. 2 is in that the first storage space 100 in this embodiment is a read-only storage space while the second storage space 102 is an accessible storage space. The management method of this embodiment is to run the step S20 firstly, connect the storage device with a computer system 2. Then take the step S22, according to a selection signal of the first management identity, the control unit 12 of the storage device 1 chooses the first storage space 100 that is simulated into a compact-disc read only memory (CD-ROM) and is saved with an application program (AP) or a driving program. Next run the step S24, the computer system 2 reads the application program or the driving program of the first storage for execution of the application program or the driving program.

Once the storage device 1 of the present invention is applied to a digital photo frame, the first storage space 100 of the digital photo frame is saved with the driving program and an application program for photography editing. When the digital photo frame is connected with the computer system 2, the digital photo frame auto-runs the driving program as well as the application program for photography editing thereof. Thus the user can use digital photo frame and perform photography editing without extra installation so that the convenience of use of the storage device is increased. Moreover, both the driving program of the digital photo frame and the application program for photography editing are saved in the read only storage space, deletion of the programs can be avoided. Next, run the step S26, the control unit 12 chooses the second storage space 102 according to the selection signal of the second management identity. That means the control unit 12 shifts the management identity into a common accessible storage space for convenience of data storage/retrieval of the storage device.

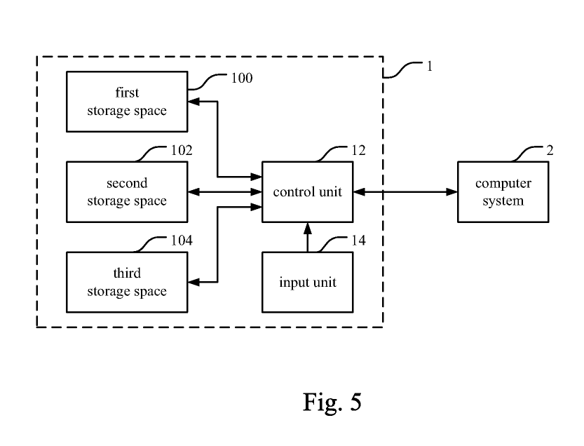

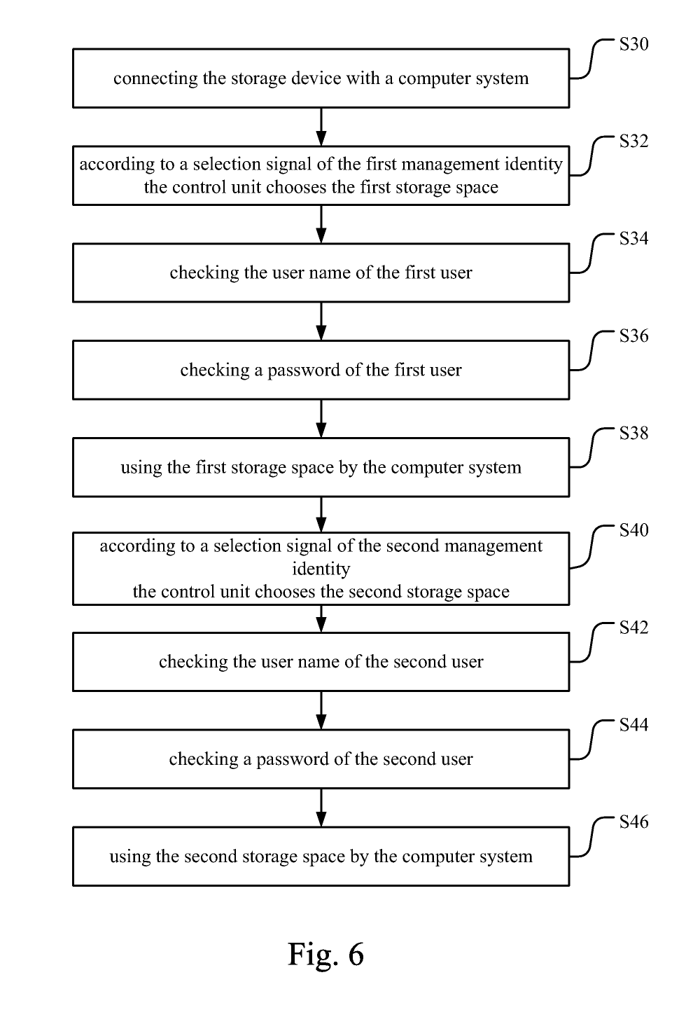

Refer to FIG. 5 & FIG. 6, a further embodiment is disclosed. The difference between this embodiment and above one is in that the storage device 1 has several storage spaces such as a first storage space 100 and a second storage space 102, both are accessible storage spaces for different users. A management method includes the steps of: the step S30, connect the storage device 1 with a computer system 2. Then run the step S32, according to a selection signal of the first management identity, the control unit 12 chooses the first storage space 100 and provides the first storage space 100 to a first user. Next perform an identification process, as shown in the step S34 and the step S36, check the user name of the first user and input a password preset by the first user. Then the user uses the first storage space by the computer system 2.

Once an another(second) user wants to use the storage device, run the step S40, the control unit 12 selects the second storage space 102 for the second user according to a selection signal of the second management identity. Then take the step S42 and the step S44, identify the user and the password. That means to check the user name and the password of the second user. Next run the step S46, the user can use the second storage space 102 by the computer system 2. Therefore, by shift of the management identity of the storage device and addition of the identification process, the convenience of use of the storage device 1 is improved while the problem of data jacking is also prevented. Especially for storage devices in enterprises, the storage device according to the present invention enables different users to use the same one storage device 1 while preventing others from accessing personal information.

In addition, the storage device of the present invention further includes a third storage space 104 for a third user to use the same storage device 1. The storage device may provide more storage spaces for more users.

In summary, storage device with multiple management identities according to the present invention includes a first storage space, and a second storage space while the first storage space corresponds to a first management identity and the second storage space corresponds to a second management identity. A management method thereof is by a control unit to the first storage space or the second storage space according to a selection signal corresponding to the first management identity or the second management identity so as to provide the first storage space or the second storage space being used the a computer system. Therefore, the convenience of use of the storage device is increased and the data safety is improved.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A storage device with multiple management identities comprising:
a first storage space corresponding to a first management identity;
a second storage space corresponding to a second management identity; and
a control unit coupled to the first storage space and the second storage space and selecting the first storage space or the second storage space to be used by a computer system according to a selection signal corresponding to the first management identity or the second management identity.

2. The device as claimed in claim 1, wherein the first storage space is a read only storage space and is saved with an application program (AP).

3. The device as claimed in claim 2, wherein the read only storage space is a compact-disc read only memory (CD-ROM).

4. The device as claimed in claim 2, wherein the read only storage space is saved with a piece of data.

5. The device as claimed in claim 1, wherein the second storage space is an accessible storage space.

6. The device as claimed in claim 1, wherein the first storage space as well as the second storage space is an accessible storage space.

7. The device as claimed in claim 1, wherein the storage device further comprising:
an input unit coupled to the control unit and generating the selection signal according to the first management identity or the second management identity.

8. The device as claimed in claim 7, wherein the input unit is a push button.

9. The device as claimed in claim 1, wherein while the storage device connecting with the computer system, the computer system generates the selection signal according to the first management identity or the second management identity.

10. The device as claimed in claim 9, wherein the computer system further comprising an input interface that generates the selection signal according to the first management identity or the second management identity.

11. The device as claimed in claim 1, wherein while the control unit selecting the first storage space or the second storage space, the control unit further performs an identification process.

12. The device as claimed in claim 11, wherein the identification process comprising checking a user name.

13. The device as claimed in claim 11, wherein the identification process comprising confirming a password.

14. The device as claimed in claim 1, wherein the storage device is disposed on a portable device.

15. The device as claimed in claim 1, wherein the storage device is disposed on a plug and play device.

16. A management method of a storage device with multiple management identities and having a first storage space corresponding to a first management identity as well as a second storage space corresponding to a second management identity comprising a step of:
selecting the first storage space or the second storage space according to a selection signal corresponding to the first management identity or the second management identity to be used by a computer system.

17. The method as claimed in claim 16, wherein the first storage space is a read only storage space and is saved with an application program (AP).

18. The method as claimed in claim 17, wherein the read only storage space is a compact-disc read only memory (CD-ROM).

19. The method as claimed in claim 17, wherein the read only storage space is saved with a piece of data.

20. The method as claimed in claim 16, wherein the second storage space is an accessible storage space.

21. The method as claimed in claim 16, wherein the first storage space as well as the second storage space is an accessible storage space.

22. The method as claimed in claim 16, wherein while a control unit selecting the first storage space or the second storage space, an identification process is further performed.

23. The method as claimed in claim 22, wherein the identification process comprising checking a user name.

24. The method as claimed in claim 22, wherein the identification process comprising confirming a password.
